(19) United States
(12) Patent Application Publication
(10) Pub. No.: US 2026/0153390 A1
(43) Pub. Date: Jun. 4, 2026

(54) DETECTION DEVICE

(71) Applicant: Japan Display Inc., Tokyo (JP)

(72) Inventor: Yosuke HYODO, Tokyo (JP)

(21) Appl. No.: 19/400,965

(22) Filed: Nov. 25, 2025

(30) Foreign Application Priority Data
Dec. 3, 2024 (JP) 2024-209995

(51) Int. Cl. G01L 1/22; G01L 5/1623

(52) U.S. Cl. CPC G01L 1/2293; G01L 5/1623

(57) ABSTRACT

According to an aspect, a detection device includes: an array substrate and a sensor layer facing the array substrate. The array substrate includes: a first surface facing the sensor layer; and a plurality of detection electrodes provided to the first surface. The detection electrodes each includes: a first detection portion; and a second detection portion disposed closer to the sensor layer than the first detection portion.

### CROSS-REFERENCE TO RELATED APPLICATION

This application claims the benefit of priority from Japanese Patent Application No. 2024-209995 filed on December 3, 2024, the entire contents of which are incorporated herein by reference.

### BACKGROUND

### 1. Technical Field

What is disclosed herein relates to a detection device.

### 2. Description of the Related Art

It is known that there are detection devices that detect a load (force) acting vertically on a detection surface. The detection device includes a common electrode, detection electrodes, and a sensor layer in contact with the common electrode and the detection electrodes. The sensor layer described in Japanese Patent Application Laid-open Publication No. 2018-146489 includes a body made of rubber, for example, and a plurality of conductive particles dispersed in the body. When force is applied to the sensor layer, the body deforms, and the conductive particles come into contact with each other. As a result, the resistance of the sensor layer decreases, and a current flows from the common electrode to the detection electrodes via the sensor layer.

It is desirable for detection devices to expand the range of detectable force values (hereinafter referred to as a "force-sensing range"). If the resistance of the sensor layer is increased, the force-sensing range is expanded, but the output value from the detection electrode is reduced, resulting in reduced sensitivity. Therefore, it is desirable to develop a detection device that can expand the force-sensing range while preventing reduction in sensitivity.

For the foregoing reasons, there is a need for a detection device that can expand a force-sensing range while preventing reduction in sensitivity.

### SUMMARY

According to an aspect, a detection device includes: an array substrate and a sensor layer facing the array substrate. The array substrate includes: a first surface facing the sensor layer; and a plurality of detection electrodes provided to the first surface. The detection electrodes each includes: a first detection portion; and a second detection portion disposed closer to the sensor layer than the first detection portion.

### BRIEF DESCRIPTION OF THE DRAWINGS

FIG. 1 is a schematic front view of a detection device according to a first embodiment;

FIG. 2 is a schematic of a section of the detection device according to the first embodiment, and more specifically a schematic sectional view taken along line II-II of FIG. 3;

FIG. 3 is an enlarged view of part (one individual detection region) of a first surface of an array substrate according to the first embodiment viewed from a sensor layer;

FIG. 4 is an enlarged view of a part near a first contact hole and a detection electrode in FIG. 2;

FIG. 5 is a circuit diagram of a circuit configuration of the detection device according to the first embodiment;

FIG. 6 is a sectional view schematically illustrating a state where force is applied to the detection device according to the first embodiment;

FIG. 7 is a sectional view schematically illustrating a state where force larger than that in FIG. 6 is applied;

FIG. 8 is a sectional view schematically illustrating a state where force larger than that in FIG. 7 is applied;

FIG. 9 is a sectional view schematically illustrating a state where force larger than that in FIG. 8 is applied;

FIG. 10 is a sectional view of the detection device according to a first comparative example along a stacking direction;

FIG. 11 is a graph indicating the relation between the force applied to the detection surface and the amount of current flowing to the detection electrode in the detection devices according to the first embodiment, the first comparative example, and a second comparative example;

FIG. 12 is a sectional view of the detection device according to a first modification along the stacking direction;

FIG. 13 is a sectional view of the detection device according to a second modification along the stacking direction, and more specifically a sectional view taken along line XIII-XIII of FIG. 14;

FIG. 14 is an enlarged view of part (one individual detection region) of the first surface of the array substrate according to the second modification viewed from the sensor layer;

FIG. 15 is a sectional view of the detection device according to a third modification along the stacking direction, and more specifically a sectional view taken along line XV-XV of FIG. 16;

FIG. 16 is an enlarged view of part (one individual detection region) of the first surface of the array substrate according to the third modification viewed from the sensor layer;

FIG. 17 is a sectional view of the detection device according to a fourth modification along the stacking direction, and more specifically a sectional view taken along line XVII-XVII of FIG. 17; and

FIG. 18 is an enlarged view of part (one individual detection region) of the first surface of the array substrate according to the fourth modification viewed from the sensor layer.

### DETAILED DESCRIPTION

Exemplary aspects (embodiments) to embody a detection device according to the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than those in the actual aspect. These elements, however, are given by way of example only and are not intended to limit interpretation of the present disclosure. In the present specification and the drawings, components similar to those previously described with reference to previous drawings are denoted by the same reference numerals, and detailed explanation thereof may be appropriately omitted.

To describe an aspect regarding a certain structure on which or above which another structure is disposed in the present specification and the claims, when "on" is simply used, it indicates both the following cases unless otherwise noted: a case where the other structure is disposed directly on and in contact with the certain structure, and a case where the other structure is disposed above the certain structure with yet another structure interposed therebetween.

### First Embodiment

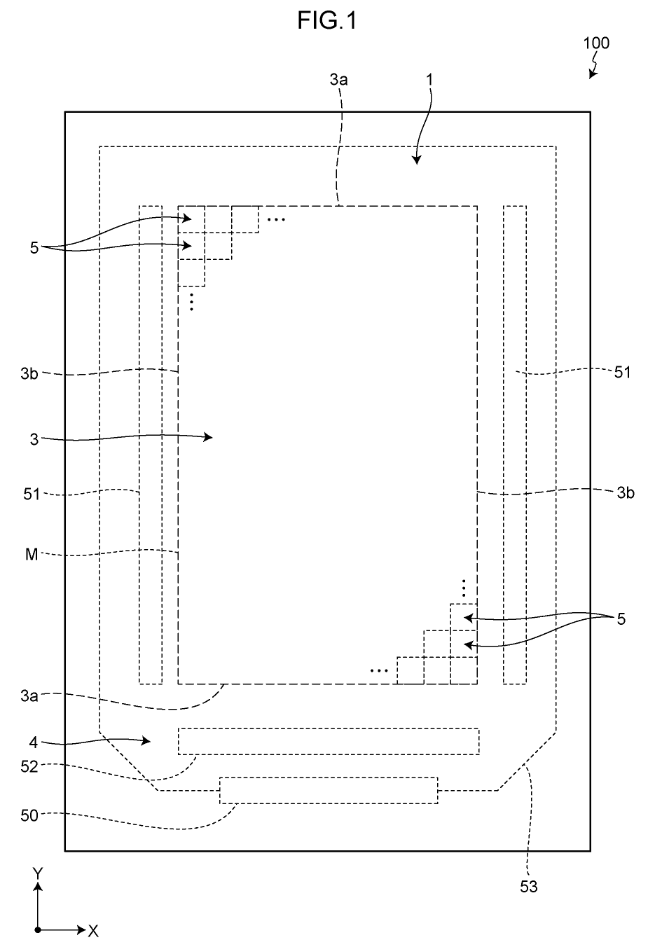

FIG. 1 is a schematic front view of a detection device according to a first embodiment. A detection device 100 is a device that detects force acting on a detection surface

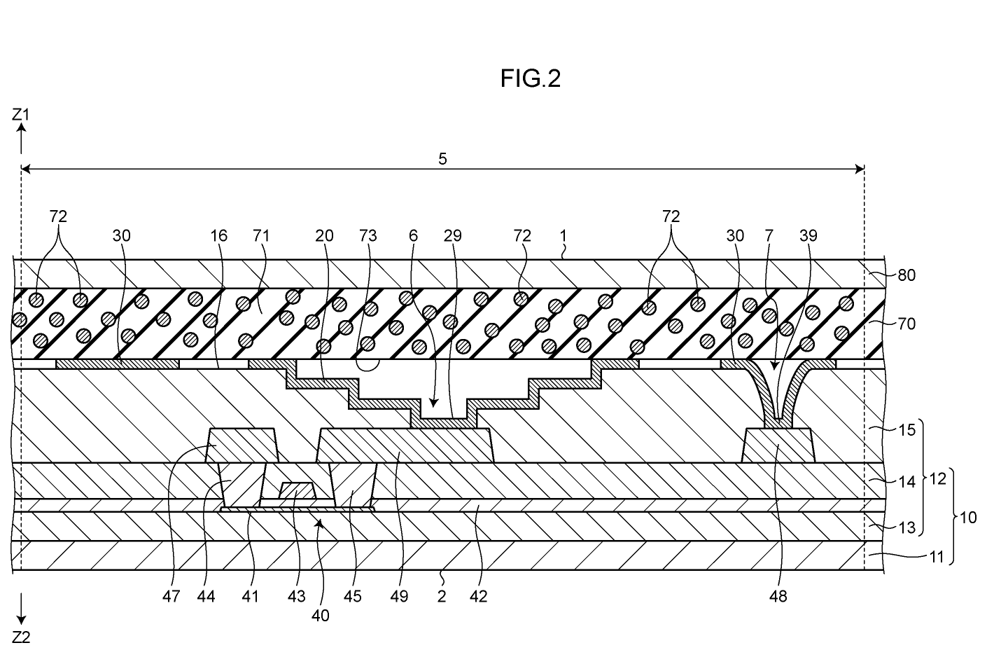

1. As illustrated in FIG. 1, the detection device 100 is formed in a flat plate shape. The detection device 100 has a flat front surface (detection surface 1) and a flat back surface 2 (not illustrated in FIG. 1; refer to FIG. 2). The detection device 100 has a rectangular shape when viewed along the direction normal to the detection surface 1. The detection device 100 illustrated in FIG. 1 has the flat detection surface 1, so it can detect force distribution in the detection surface 1.

The detection surface 1 is divided into a detection region 3 in which force can be detected and a peripheral region 4 in which force cannot be detected. The detection region 3 is positioned at the center of the detection surface 1. The peripheral region 4 is formed in a frame shape and surrounds the outer periphery of the detection region 3.

The detection region 3 is formed in a rectangular shape when viewed along the direction normal to the detection surface 1. Therefore, an outer frame M of the detection region 3 has a pair of short sides 3a and a pair of long sides 3b. In the following description, the direction parallel to the detection surface 1 and parallel to the short side 3a is referred to as a first direction X. The direction parallel to the detection surface 1 and parallel to the long side 3b is referred to as a second direction Y. Thus, the second direction Y is a direction orthogonal to (intersecting) the first direction X. The direction parallel to the detection surface 1 may be hereinafter referred to as a planar direction.

The detection region 3 is divided into a plurality of individual detection regions 5. In other words, the detection region 3 is composed of the individual detection regions 5. A force value is detected in each of the individual detection regions 5. When viewed along the direction normal to the detection surface 1, the individual detection region 5 has a square shape. The individual detection regions 5 are arrayed in the first direction X and the second direction Y.

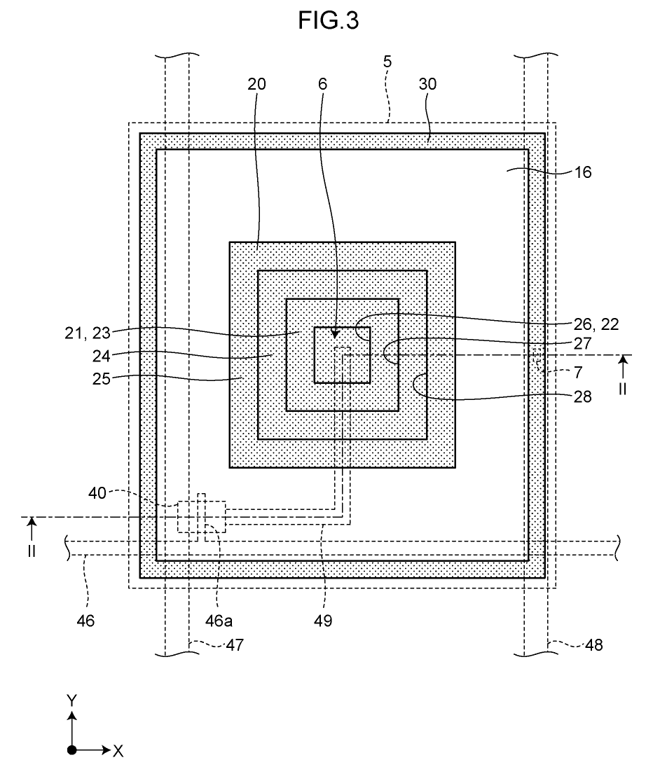

FIG. 2 is a schematic of a section of the detection device according to the first embodiment, and more specifically a schematic sectional view taken along line II-II of FIG. 3. As illustrated in FIG. 2, the detection device 100 includes an array substrate 10, a sensor layer 70, and a protective layer 80 stacked in this order. In the following description, the direction in which the array substrate 10, the sensor layer 70, and the protective layer 80 are stacked is referred to as a stacking direction. The direction normal to the detection surface 1 described above is the same meaning as the stacking direction. In the stacking direction, the direction in which the sensor layer 70 is disposed when viewed from the array substrate 10 is referred to as a first stacking direction Z1, and the direction opposite thereto is referred to as a second stacking direction Z2. Viewing from the first stacking direction Z1 is referred to as plan view.

The array substrate 10 includes a base 11 and an array layer 12 formed in the first stacking direction Z1 with respect to the base 11. The base 11 is a plate-like member that supports the array layer 12 and has an insulating property. While the base 11 is a flexible substrate made of polyimide, for example, the present disclosure is not limited thereto. The surface of the base 11 facing in the second stacking direction Z2 serves as the back surface 2 of the detection device 100.

The array layer 12 includes a first insulating layer 13, a second insulating layer 14, and a third insulating layer 15 stacked in this order on the surface of the base 11 facing in the first stacking direction Z1. The space between the first insulating layer 13 and the second insulating layer 14 is provided with a gate insulating film 42 of a transistor 40, which will be described later.

The first insulating layer 13, the second insulating layer 14, and the third insulating layer 15 are made of insulating material. The insulating material may be either inorganic or organic material. The third insulating layer 15 is a layer (planarization film) for planarizing a first surface 16 of the array layer 12 in the first stacking direction Z1. While the array layer 12 according to the present embodiment includes three insulating layers, the number of insulating layers according to the present disclosure is not particularly limited.

The first surface 16 of the array layer 12 is provided with detection electrodes 20 and common electrodes 30 and has first contact holes 6 and second contact holes 7.

FIG. 3 is an enlarged view of part (one individual detection region) of the first surface of the array substrate according to the first embodiment viewed from the sensor layer. In FIG. 3, the detection electrode 20 and the common electrode 30 are shaded with dots to make them easier to see. The detection electrode 20 and the common electrode 30 are metal films (metal layers) made of metal material, such as indium tin oxide (ITO), and formed on the first surface 16.

As illustrated in FIG. 3, each detection electrode 20 is disposed in a corresponding one of the individual detection regions 5. In other words, a plurality of detection electrodes 20 are formed on the first surface 16. The detection electrode 20 is disposed at the center of the individual detection region 5. The outline of the detection electrode 20 has a square shape in plan view.

As illustrated in FIG. 3, each common electrode 30 is disposed in a corresponding one of the individual detection regions 5. In other words, a plurality of the common electrodes 30 are formed on the first surface 16. The common electrode 30 is formed in a square (quadrilateral) frame shape in plan view. The detection electrode 20 is disposed inside the square frame of the common electrode 30, and the common electrode 30 surrounds the detection electrode 20. The common electrode 30 and the detection electrode 20 are separated in the planar direction and are not coupled to each other on the first surface 16.

As illustrated in FIG. 2, the first contact hole 6 and the second contact hole 7 are holes extending from the first surface 16 of the array substrate 10 in the second stacking direction Z2. A coupling line 49, which will be described later, is disposed in the second stacking direction Z2 with respect to the first contact hole 6. A reference potential line 48, which will be described later, is disposed in the second stacking direction Z2 with respect to the second contact hole 7. Each first contact hole 6 and each second contact hole 7 are formed in one corresponding individual detection region 5.

As illustrated in FIG. 3, the first contact hole 6 is provided at the center of the individual detection region 5. The second contact hole 7 is disposed in a portion of the first surface 16 overlapping the common electrode 30. As illustrated in FIG. 2, a part of the detection electrode 20 is disposed in the first contact hole 6 and serves as a first contact portion 29 coupled to the coupling line 49. A part of the common electrode 30 is disposed in the second contact hole 7 and serves as a second contact portion 39 coupled to the reference potential line 48.

As illustrated in FIG. 2, the section of the inner peripheral surface of the first contact hole 6 along the stacking direction has a stepped shape. Therefore, the detection electrode 20 stacked on the inner peripheral surface of the first contact hole 6 also has a stepped sectional shape. The details will be described below.

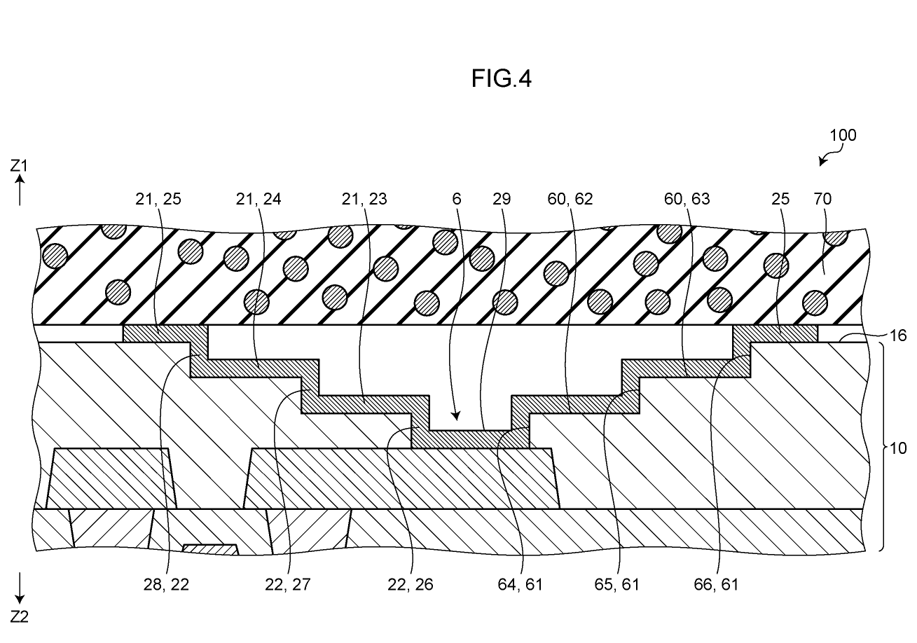

FIG. 4 is an enlarged view of a part near the first contact hole and the detection electrode in FIG. 2. As illustrated in FIG. 4, the inner peripheral surface of the first contact hole 6 has two horizontal surfaces 60 extending in the planar direction and three vertical surfaces 61 extending in the stacking direction. The two horizontal surfaces 60 are a first horizontal surface 62 and a second horizontal surface 63 arranged in this order from the second stacking direction Z2. The three vertical surfaces 61 are a first vertical surface 64, a second vertical surface 65, and a third vertical surface 66 arranged in this order from the second stacking direction Z2. The first vertical surface 64 extends from the first horizontal surface 62 in the second stacking direction Z2. The second vertical surface 65 couples the first horizontal surface 62 and the second horizontal surface 63. The third vertical surface 66 couples the second horizontal surface 63 and the first surface 16.

The detection electrode 20 includes the first contact portion 29, three planar portions 21 extending in the planar direction, and three vertical walls 22 extending in the stacking direction. The three planar portions 21 are a first planar portion 23 stacked on the first horizontal surface 62, a second planar portion 24 stacked on the second horizontal surface 63, and a third planar portion 25 stacked on the first surface 16. In the specification, the first planar portion 23 may be referred to as a first detection portion. The second planar portion 24 may be referred to as a second detection portion.

The three vertical walls 22 are a first vertical wall 26 extending along the first vertical surface 64, a second vertical wall 27 extending along the second vertical surface 65, and a third vertical wall 28 extending along the third vertical surface 66. The first vertical wall 26 couples the first contact portion 29 to the first planar portion 23. The second vertical wall 27 couples the first planar portion 23 and the second planar portion 24. The third vertical wall 28 couples the second planar portion 24 and the third planar portion 25.

As illustrated in FIG. 3, the first planar portion 23, the second planar portion 24, the third planar portion 25, the first vertical wall 26, the second vertical wall 27, and the third vertical wall 28 each have a square frame shape (annular shape) in plan view. In other words, the first horizontal surface 62, the second horizontal surface 63, the first vertical wall 26, the second vertical wall 27, and the third vertical wall 28 of the first contact hole 6 also each have a square frame shape (annular shape) in plan view. Thus, the detection electrode 20 is gradually recessed in the second stacking direction Z2 toward the center.

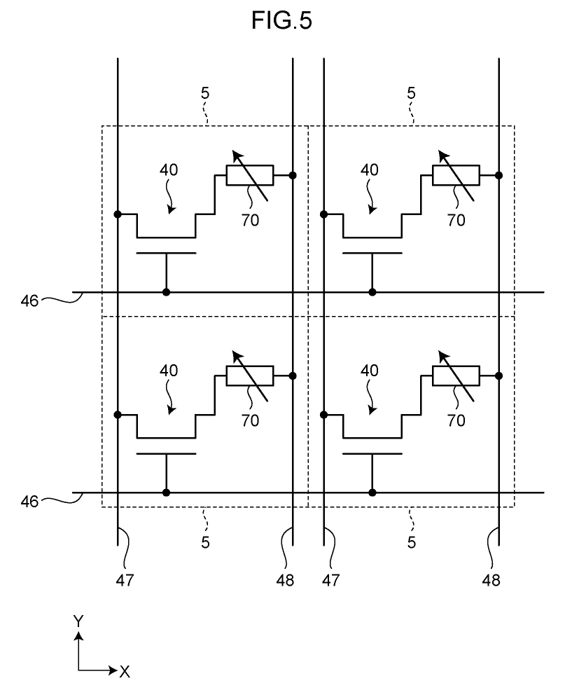

FIG. 5 is a circuit diagram of a circuit configuration of the detection device according to the first embodiment. As illustrated in FIG. 5, the array layer 12 is provided with a transistor 40, a gate line 46, a signal line 47, the reference potential line 48, a coupling member 50 (refer to FIG. 1), a gate line drive circuit 51 (refer to FIG. 1), a signal line selection circuit 52 (refer to FIG. 1), and a common line 53 (refer to FIG. 1). A plurality of the transistors 40, a plurality of the gate lines 46, a plurality of the signal lines 47, and a plurality of the reference potential lines 48 are formed in the array layer 12 (array substrate 10).

The transistor 40 is a switching element. The transistors 40 are provided to the respective individual detection regions 5. As illustrated in FIG. 2, the transistor 40 includes a semiconductor layer 41, the gate insulating film 42, a gate electrode 43, a drain electrode 44, and a source electrode 45. The end of the source electrode 45 in the first stacking direction Z1 is coupled to the coupling line 49. The coupling line 49 extends in the planar direction (refer to FIG. 3) and is coupled to the first contact portion 29. Therefore, the source electrode 45 is coupled to the detection electrode 20 via the coupling line 49 and the first contact portion 29.

As illustrated in FIG. 5, each of the gate lines 46 extends in the first direction X. The gate lines 46 are arrayed in the second direction Y. As illustrated in FIG. 4, the gate line 46 is provided with a branch 46a extending in the second direction Y. The branch 46a is provided to each individual detection region 5. The gate line 46 is coupled to the gate electrodes 43 (refer to FIG. 2) of the respective transistors 40 arrayed in the first direction X via the branches 46a.

As illustrated in FIG. 5, each of the signal lines 47 extends in the second direction Y. The signal lines 47 are arrayed in the first direction X. The signal line 47 is coupled to the drain electrodes 44 (refer to FIG. 2) of the respective transistors 40 arrayed in the second direction Y.

As illustrated in FIG. 5, each of the reference potential lines 48 extends in the second direction Y. The reference potential lines 48 are arrayed in the first direction X. As illustrated in FIG. 2, the reference potential line 48 is coupled to the second contact portion 39 of the common electrode 30.

As illustrated in FIG. 1, the coupling member 50, the gate line drive circuit 51, the signal line selection circuit 52, and the common line 53 are disposed in the peripheral region 4 in the array layer 12. The coupling member 50 couples the detection device 100 to a drive integrated circuit (IC) disposed outside the detection device 100. The drive IC may be mounted as a chip on film (COF) on a flexible printed circuit board or a rigid circuit board coupled to the coupling member 50. Alternatively, the drive IC may be mounted as a chip on glass (COG) in the peripheral region 4 of the array substrate 10.

The gate line drive circuits 51 are circuits that drives the gate lines 46 (refer to FIG. 5) based on various control signals from the drive IC. The gate line drive circuits 51 sequentially or simultaneously select the gate lines 46 and supply gate drive signals to the selected gate lines 46.

The signal line selection circuit 52 is a switch circuit that sequentially or simultaneously selects the signal lines 47 (refer to FIG. 5). The signal line selection circuit 52 is a multiplexer, for example. The signal line selection circuit 52 couples the selected signal lines 47 to the drive IC based on selection signal supplied from the drive IC. The detection region is provided with the transistors 40, the gate lines 46, the signal lines 47, and the reference potential line 48, so that the detection device 100 can measure changes over time in the force distribution in the plane.

The common line 53 is coupled to the drive IC via the coupling member 50 and is supplied with a certain amount of current from the drive IC. The common line 53 extends along the peripheral region and has an annular (frame-like) shape. The common line 53 is coupled to the reference potential line 48. Therefore, the common electrode 30 is supplied with a certain amount of current.

As illustrated in FIG. 2, the sensor layer 70 includes a body 71 and conductive microparticles 72. The body 71 is a deformable insulating member made of silicone rubber or the like. The conductive microparticles 72 are dispersed in the body 71. When no force is applied to the sensor layer 70, the resistance is high. By contrast, when force is applied to the sensor layer 70, and the body 71 is deformed, the conductive microparticles 72 come into contact with or into proximity to each other, and the resistance of the sensor layer 70 decreases. A surface 73 of the sensor layer 70 in the second stacking direction Z2 is in contact with the third planar portion 25 of the detection electrode 20 and the common electrode 30.

The protective layer 80 is made of elastically deformable insulating material, such as rubber and resin. The surface of the protective layer 80 in the first stacking direction Z1 serves as the detection surface 1. The sensor layer 70 and the protective layer 80 integrally formed are bonded to the array substrate 10 with a frame member (not illustrated) interposed therebetween in the area overlapping the peripheral region 4.

Next, the operation of the detection device 100 is described. When no force is applied to the detection surface 1 as illustrated in FIG. 2, the resistance of the sensor layer 70 is large. Therefore, no current flows from the common electrode 30 to the sensor layer 70.

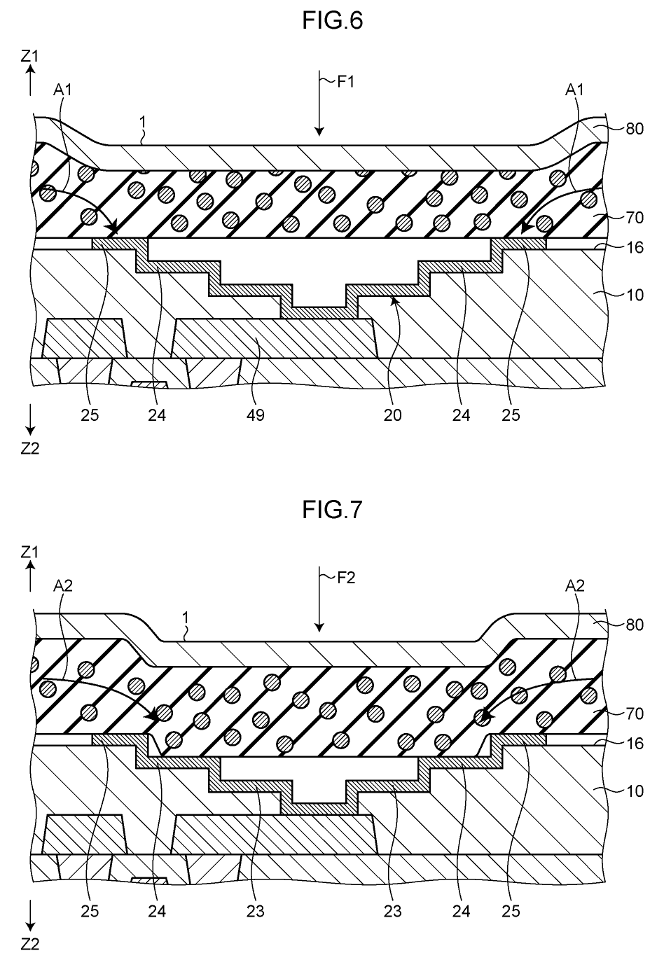

By contrast, when force is applied to the detection surface 1, a compressive load in the stacking direction acts on the sensor layer 70, and the resistance of the sensor layer 70 decreases. As a result, a current flows from the common electrode 30 to the detection electrode 20 via the sensor layer 70 (refer to arrow A1 in FIG. 6). As the force applied to the detection surface 1 increases, the amount of decrease in resistance of the sensor layer 70 increases. In other words, the amount of current flowing from the common electrode 30 to the detection electrode 20 increases. Thus, the amount of current flowing to the detection electrode 20 is proportional to the magnitude of the applied force.

The electrical signal (current value) input to the detection electrode 20 is output by the signal line 47 to the drive IC. Based on the magnitude of the current value, the drive IC derives the load input to the individual detection region 5.

The amount of current flowing from the common electrode 30 to the detection electrode 20 via the sensor layer 70 varies with the increase or decrease in the contact area between the sensor layer 70 and the detection electrode 20, besides the increase or decrease in resistance of the sensor layer 70 itself. Specifically, the amount of current flowing to the detection electrode 20 increases as the contact area between the sensor layer 70 and the detection electrode 20 increases. The contact area between the sensor layer 70 and the detection electrode 20 according to the present embodiment changes as follows depending on the increase or decrease in force.

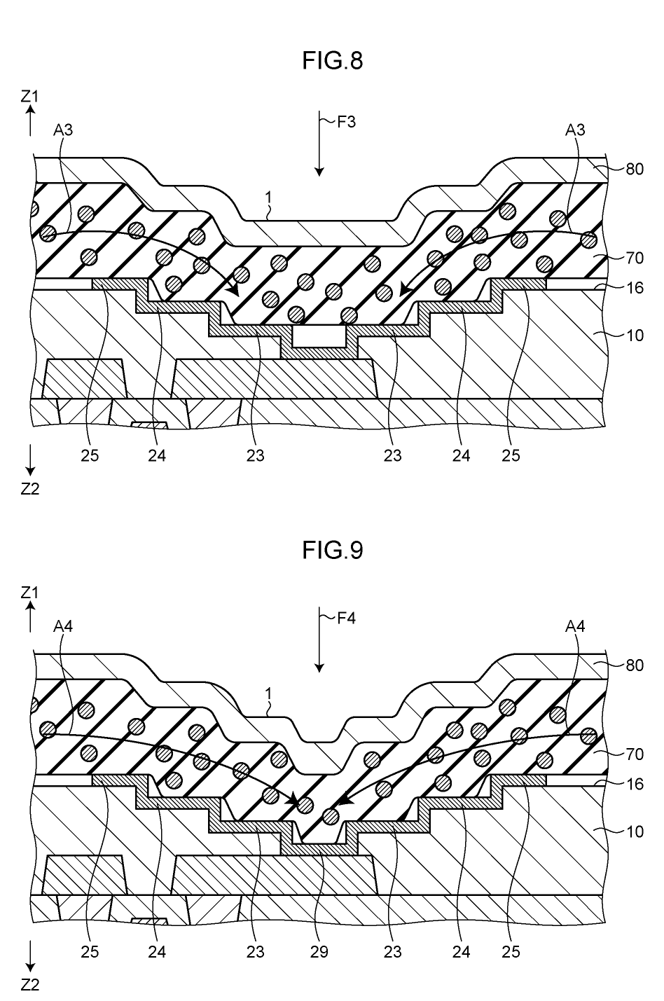

FIG. 6 is a sectional view schematically illustrating a state where force is applied to the detection device according to the first embodiment. FIG. 7 is a sectional view schematically illustrating a state where force larger than that in FIG. 6 is applied. FIG. 8 is a sectional view schematically illustrating a state where force larger than that in FIG. 7 is applied. FIG. 9 is a sectional view schematically illustrating a state where force larger than that in FIG. 8 is applied.

As illustrated in FIG. 6, when force F1 applied to the detection surface 1 is relatively small, the sensor layer 70 comes into contact only with the third planar portion 25 of the detection electrode 20. When force F2 applied to the detection surface 1 is larger than the force F1 (F2 > F1), the sensor layer 70 bends in the second stacking direction Z2 and comes into contact with the second planar portion 24 as illustrated in FIG. 7. In other words, the sensor layer 70 comes into contact with the third planar portion 25 and the second planar portion 24 of the detection electrode 20, thereby increasing the contact area. Therefore, the amount of current flowing to the detection electrode 20 (refer to arrow A2 in FIG. 7) is larger than that obtained when the force F1 is applied (refer to arrow A1 in FIG. 6).

As illustrated in FIG. 8, when force F3 larger than the force F2 is applied to the detection surface 1 (F3 > F2), the sensor layer 70 further bends in the second stacking direction Z2 and comes into contact with the first planar portion 23. In other words, the sensor layer 70 comes into contact with the third planar portion 25, the second planar portion 24, and the first planar portion 23 of the detection electrode 20, thereby increasing the contact area. Therefore, the amount of current flowing to the detection electrode 20 (refer to arrow A3 in FIG. 8) is larger than that obtained when the force F2 is applied (refer to arrow A2 in FIG. 7).

As illustrated in FIG. 9, when force F4 larger than the force F3 is applied to the detection surface 1 (F4 > F3), the sensor layer 70 further moves in the second stacking direction Z2 and comes into contact with the first contact portion 29. In other words, the sensor layer 70 comes into contact with the third planar portion 25, the second planar portion 24, the first planar portion 23, and the first contact portion 29, thereby increasing the contact area. Therefore, the amount of current flowing to the detection electrode 20 (refer to arrow A4 in FIG. 9) is larger than that obtained when the force F3 is applied (refer to arrow A3 in FIG. 8).

Thus, when the force increases in the present embodiment, the contact area between the sensor layer 70 and the detection electrode 20 increases, and the amount of current flowing to the detection electrode 20 also increases.

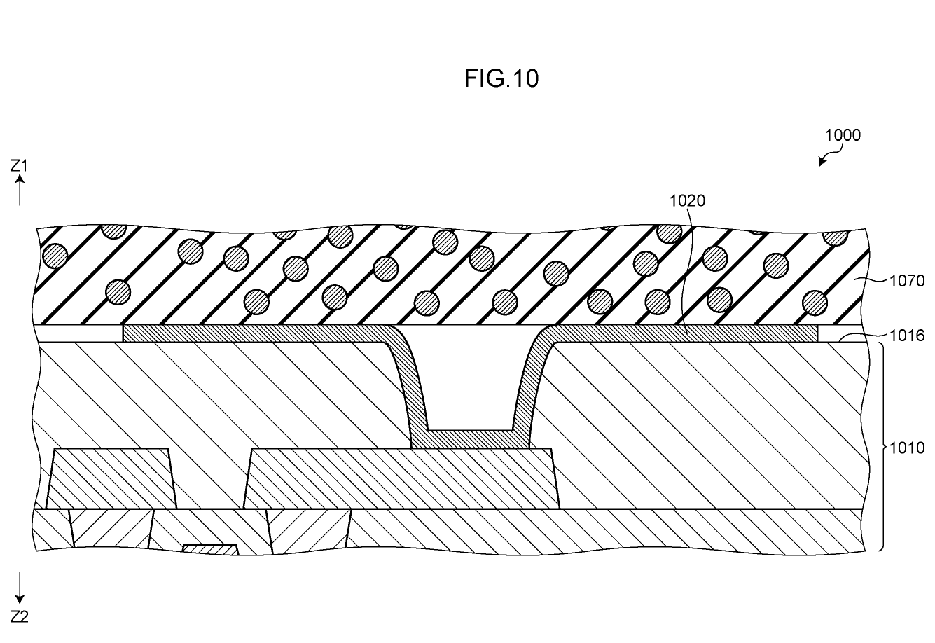

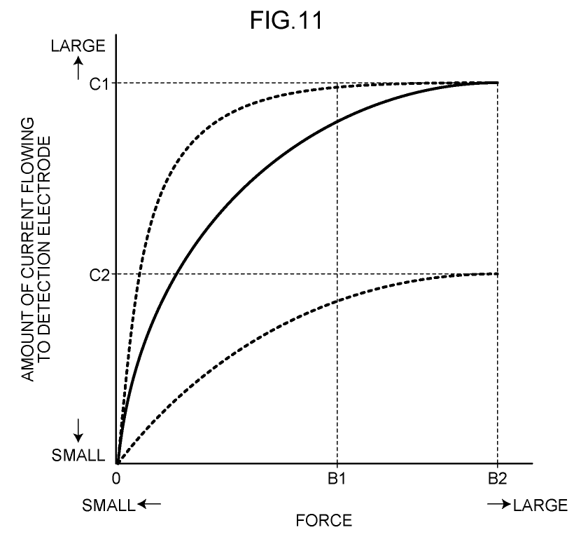

FIG. 10 is a sectional view of the detection device according to a first comparative example along the stacking direction. FIG. 11 is a graph indicating the relation between the force applied to the detection surface and the amount of current flowing to the detection electrode in the detection devices according to the first embodiment, the first comparative example, and a second comparative example. The following describes advantageous effects of the detection device 100 according to the first embodiment. First, the detection devices according to the first and the second comparative examples are described.

As illustrated in FIG. 10, a detection device 1000 according to the first comparative example is different from the first embodiment in that a detection electrode 1020 extends along a first surface 1016 of an array substrate 1010. In other words, in the detection device 1000 according to the first comparative example, the contact area between the detection electrode 1020 and a sensor layer 1070 does not change when the force applied to the detection surface increases. The resistivity of the sensor layer 1070 is equal to that of the sensor layer 70 according to the first embodiment.

The configuration of the detection device according to the second comparative example, which is not specifically illustrated, is the same as that according to the first comparative example. However, the resistivity of the sensor layer of the detection device according to the second comparative example is higher than that of the sensor layer 1070 according to the first comparative example and the sensor layer 70 according to the first embodiment.

As illustrated in FIG. 11, the resistance of the sensor layer 1070 of the detection device 1000 according to the first comparative example decreases in proportion to the magnitude of the applied force. Therefore, the amount of current flowing to the detection electrode 1020 increases. In the first comparative example, the contact area between the sensor layer 1070 and the detection electrode 1020 does not increase or decrease when the magnitude of the applied force increases or decreases. In other words, the contact area between the sensor layer 1070 and the detection electrode 1020 is large, so that the amount of current flowing to the detection electrode 1020 increases even when small force is applied. When the applied force is B1, the detection device 1000 according to the first comparative example produces the maximum output value C1 (the amount of current flowing to the detection electrode 1020 is the maximum). Therefore, the force-sensing range (range in which the force can be detected) of the detection device 1000 is force values of 0 (zero) to B1.

By contrast, the detection device according to the second comparative example has high resistivity of the sensor layer, and the output value (amount of current flowing to the detection electrode) is not the maximum when the force B1 is applied. Therefore, the detection device according to the second comparative example can detect force larger than the force B1. The detection device according to the second comparative example produces the maximum output value (the amount of current flowing to the detection electrode is the maximum) when a force value B2 larger than the force B1 is applied. Therefore, the force-sensing range of the detection device according to the second comparative example is forces of 0 (zero) to B2. The detection device according to the second comparative example, however, has a small output value because the resistivity of the sensor layer is high. In other words, the maximum output value C2 of the detection device according to the second comparative example is smaller than the maximum output value C1 of the detection device 1000 according to the first comparative example, and the sensitivity is reduced.

By contrast, in the detection device 100 according to the first embodiment, the contact area between the sensor layer 70 and the detection electrode 20 does not increase unless the force applied to the detection surface 1 increases. In other words, the amount of current flowing to the detection electrode 20 can be kept small. As a result, in the detection device 100 according to the first embodiment, the amount of current flowing to the detection electrode 20 is smaller than in the first comparative example when the force B1 is applied. Therefore, the force-sensing range of the detection device 100 according to the first embodiment is forces of 0 (zero) to B2, which is larger than that of the first comparative example. The resistivity of the sensor layer 70 according to the first embodiment is equal to that of the sensor layer 1070 according to the first comparative example. Therefore, the maximum output value (the amount of current flowing to the detection electrode 20 is the maximum) is C1, which is the same as in the first comparative example. In other words, the first embodiment can prevent the sensitivity from being reduced unlike the second comparative example.

As described above, the detection device 100 according to the first embodiment can prevent reduction in sensitivity and expand the force-sensing range.

The first embodiment has been described above. Next, modifications are described in which the detection electrode according to the first embodiment is partially modified. The following describes the modifications focusing on the differences from the first embodiment.

### First Modification

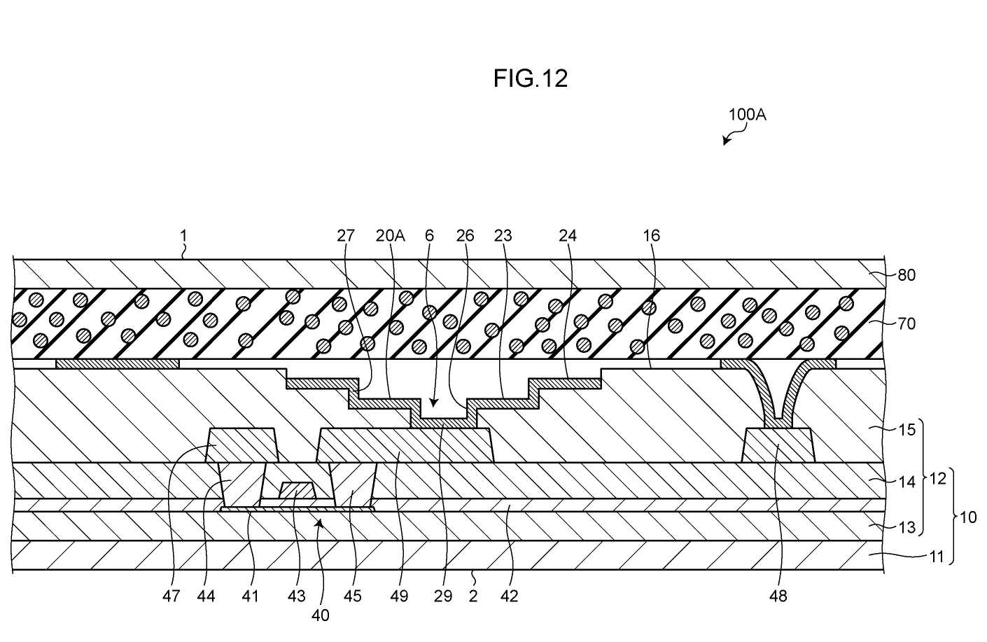

FIG. 12 is a sectional view of the detection device according to a first modification along the stacking direction. As illustrated in FIG. 12, a detection electrode 20A of a detection device 100A according to the first modification is different from the first embodiment in that it does not include the third planar portion 25 or the third vertical wall 28. With this configuration, the sensor layer 70 and the detection electrode 20A are not in contact with each other when no force is applied. Therefore, noise is less likely to be input to the detection electrode 20A. The power consumption of the detection device 100A can be reduced.

Next, other modifications are described in which not only the detection electrode but also the shape of the first surface is modified.

### Second Modification

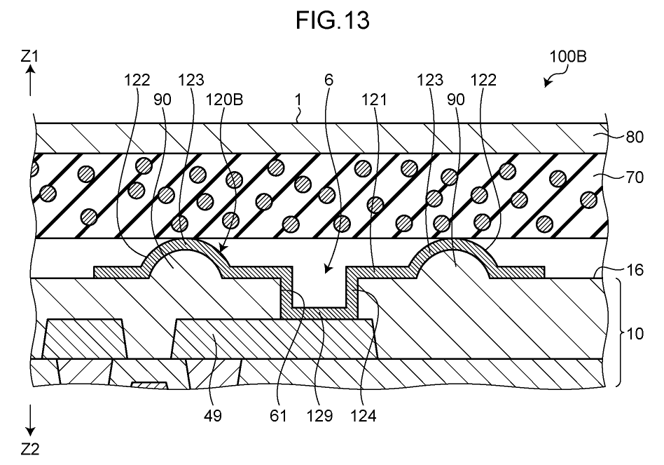

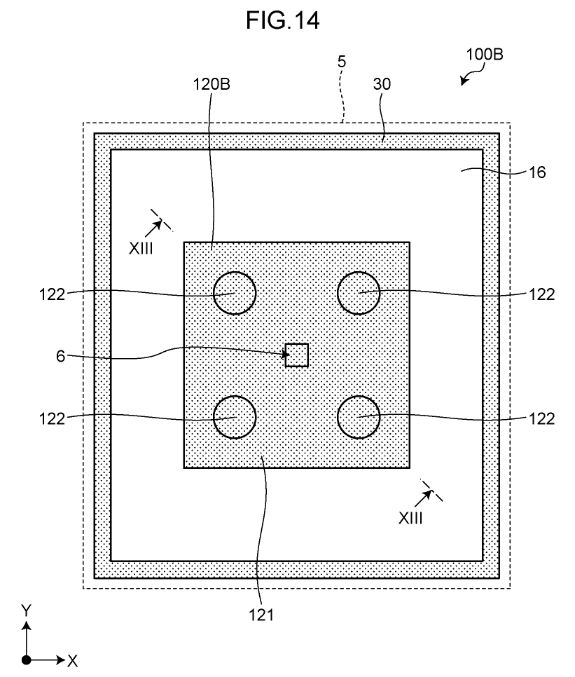

FIG. 13 is a sectional view of the detection device according to the second modification along the stacking direction, and more specifically a sectional view taken along line XIII-XIII of FIG. 14. FIG. 14 is an enlarged view of part (one individual detection region) of the first surface of the array substrate according to the second modification viewed from the sensor layer. As illustrated in FIG. 13, the first contact hole 6 on the first surface 16 of the array substrate 10 in the second modification is different from the first embodiment in that it linearly extends in the stacking direction. Therefore, the inner surface of the first contact hole 6 is only one vertical surface 61 extending in the stacking direction. The second modification is different from the first embodiment in that the first surface 16 of the array substrate 10 has hemispherical projections 90 protruding in the first stacking direction Z1. The projection 90 has a semicircular section along the stacking direction.

A detection electrode 120B is stacked on the first surface 16, the first contact hole 6, and the projections 90. Therefore, the part of the detection electrode 120B stacked on the first surface 16 serves as a planar portion 121 extending in the planar direction. The part of the detection electrode 120B stacked on the first contact hole 6 serves as a vertical wall 124 and a first contact portion 129. The part of the detection electrode 120B stacked on the projection 90 serves as a semispherical protrusion 122. The sectional shape of the protrusion 122 along the stacking direction is a semicircle. The part of the protrusion 122 positioned farthest in the first stacking direction Z1 serves as an apex 123.

As illustrated in FIG. 14, four protrusions 122 (projections 90) are provided. The four protrusions 122 (projections 90) are arranged such that they are in four-fold rotational symmetry (four-fold symmetry) around the first contact hole 6. The apex 123 of the protrusion 122 is in contact with the sensor layer 70. In the specification, the planar portion 121 may be referred to as the first detection portion. The apex 123 of the protrusion 122 may be referred to as the second detection portion.

In the second modification described above, the sensor layer 70 comes into contact only with the apex 123 of the protrusion 122 when the force is small. When the force increases, the sensor layer 70 comes into contact with the part of the protrusion 122 positioned farther in the second stacking direction Z2 than the apex 123. When the force applied to the detection surface further increases, the sensor layer 70 comes into contact with the planar portion 121.

As described above, the contact area between the sensor layer 70 and the detection electrode 120B of a detection device 100B according to the second modification does not increase unless the force applied to the detection surface 1 increases. Therefore, the amount of current flowing to the detection electrode 120B can be reduced, and the force-sensing range can be expanded. The reduction in sensitivity can also be prevented.

### Third Modification

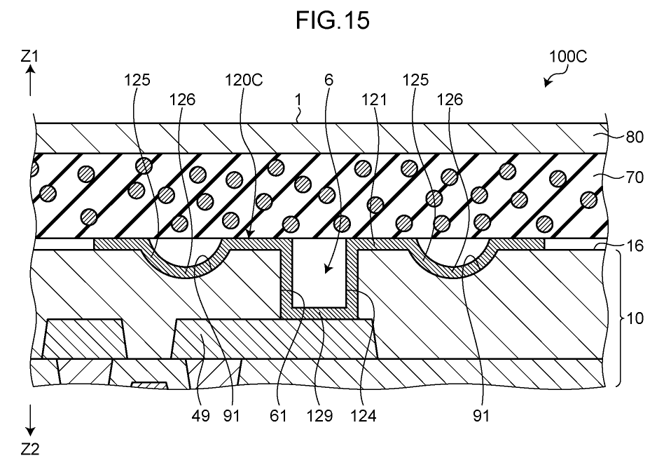

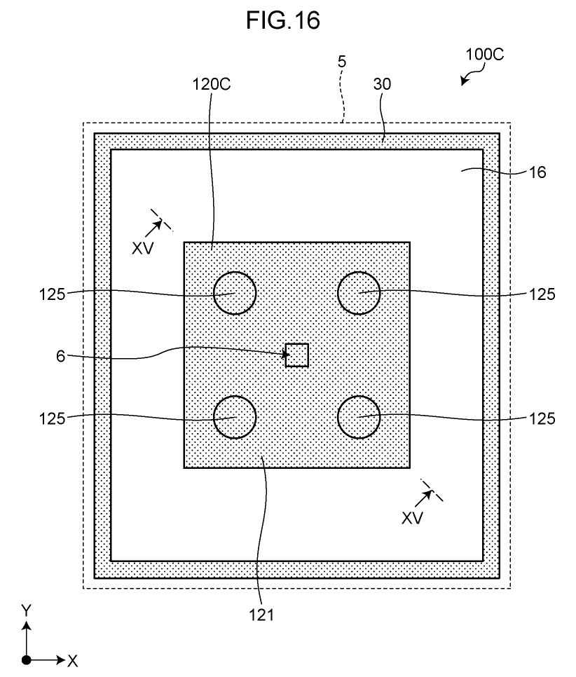

FIG. 15 is a sectional view of the detection device according to a third modification along the stacking direction, and more specifically a sectional view taken along line XV-XV of FIG. 16. FIG. 16 is an enlarged view of part (one individual detection region) of the first surface of the array substrate according to the third modification viewed from the sensor layer. As illustrated in FIG. 15, a detection device 100C according to the third modification is different from the second modification in that the array substrate 10 has recesses 91 instead of the projections 90. The recess 91 is a semispherical recess and has a semicircular section along the stacking direction.

A detection electrode 120C is stacked on the first surface 16, the first contact hole 6, and the recesses 91. Therefore, the part of the detection electrode 120C stacked on the first surface 16 serves as the planar portion 121 extending in the planar direction. The part of the detection electrode 120C stacked on the first contact hole 6 serves as the vertical wall 124 and the first contact portion 129. The part of the detection electrode 120C stacked on the recess 91 serves as a protrusion 125 with a semicircular section along the stacking direction. The protrusion 125 protrudes from the planar portion 121 in the second stacking direction Z2, that is, in the direction opposite to the direction in which the sensor layer 70 is disposed. The part of the protrusion 125 positioned farthest in the second stacking direction Z2 serves as an apex 126.

As illustrated in FIG. 16, four protrusions 125 (recesses 91) are provided. The planar portion 121 are in contact with the sensor layer 70. In the specification, the apex 126 of the protrusion 125 may be referred to as the first detection portion. The planar portion 121 may be referred to as the second detection portion.

In the third modification described above, the sensor layer 70 comes into contact only with the planar portion 121 when the force is small. When the force increases, the sensor layer 70 comes into contact with the protrusion 125 (except for the apex 126). When the force further increases, the sensor layer 70 comes into contact with the apex 126 of the protrusion 125.

As described above, the contact area between the sensor layer 70 and the detection electrode 120C of the detection device 100C according to the third modification does not increase unless the force applied to the detection surface 1 increases. Therefore, the amount of current flowing to the detection electrode 120C can be reduced, and the force-sensing range can be expanded. The reduction in sensitivity can also be prevented.

### Fourth Modification

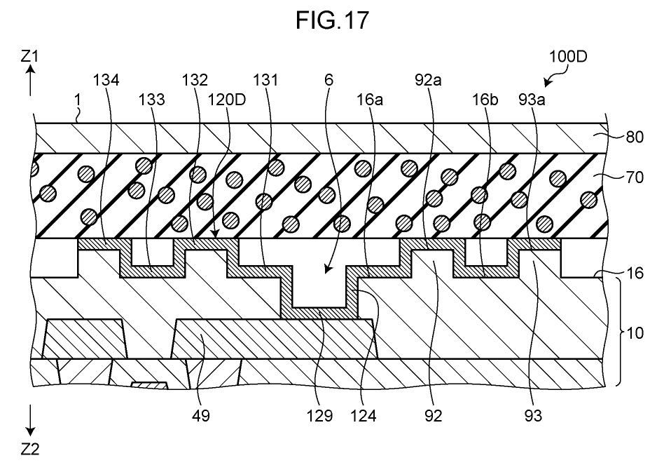

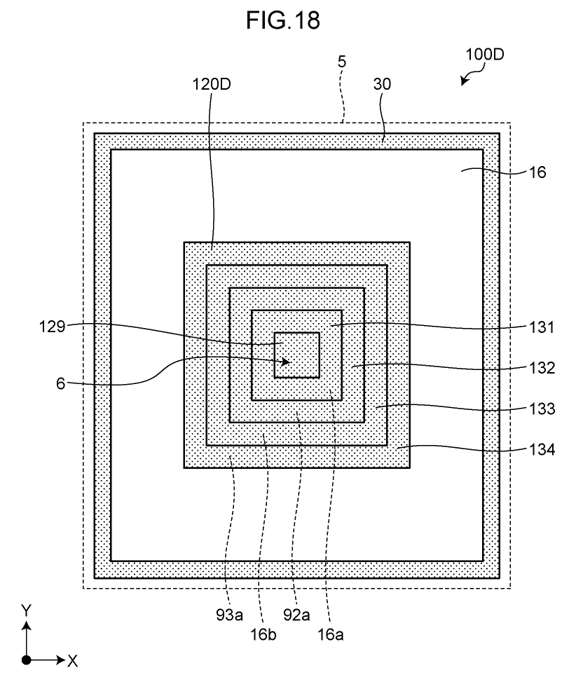

FIG. 17 is a sectional view of the detection device according to a fourth modification along the stacking direction, and more specifically a sectional view taken along line XVII-XVII of FIG. 17. FIG. 18 is an enlarged view of part (one individual detection region) of the first surface of the array substrate according to the fourth modification viewed from the sensor layer. As illustrated in FIG. 17, a detection device 100D according to the fourth modification is different from the first embodiment in that it has first projections 92 and second projections 93 protruding from the first surface 16 in the first stacking direction Z1. The first contact hole 6 on the first surface 16 of the array substrate 10 is different from the first embodiment in that it linearly extends in the stacking direction.

The first projection 92 and the second projection 93 have a rectangular sectional shape. The first projection 92 has a first projection surface 92a facing in the first stacking direction Z1 and parallel to the planar direction. The second projection 93 has a second projection surface 93a facing in the first stacking direction Z1 and parallel to the planar direction.

As illustrated in FIG. 18, the first projection 92 and the second projection 93 have a square frame shape (annular shape) in plan view. The first projection 92 is provided on the inner periphery side of the second projection 93. Therefore, part of the first surface 16 (hereinafter referred to as a first horizontal wall 16a) is provided between the first contact hole 6 and the first projection 92. Part of the first surface 16 (hereinafter referred to as a second horizontal wall 16b) is also provided between the first projection 92 and the second projection 93. The first horizontal wall 16a and the second horizontal wall 16b have a square frame shape (annular shape) in plan view.

A detection electrode 120D is stacked on the first contact hole 6, the first horizontal wall 16a, the first projection 92, the second horizontal wall 16b, and the second projection 93. The part of the detection electrode 120D stacked on the first horizontal wall 16a serves as a first planar portion 131 extending in the planar direction. The part of the detection electrode 120D stacked on the first projection surface 92a serves as a second planar portion 132 extending in the planar direction. The part of the detection electrode 120D stacked on the second horizontal wall 16b serves as a third planar portion 133 extending in the planar direction. The part of the detection electrode 120D stacked on the second projection surface 93a serves as a fourth planar portion 134 extending in the planar direction.

As illustrated in FIG. 18, the first planar portion 131, the second planar portion 132, the third planar portion 133, and the fourth planar portion 134 have a square frame shape (annular shape) around the center of the detection electrode 120D when viewed from the stacking direction. The second planar portion 132 is provided between the first planar portion 131 and the third planar portion 133 in plan view. The third planar portion 133 is provided between the second planar portion 132 and the fourth planar portion 134. As illustrated in FIG. 17, the first planar portion 131 and the third planar portion 133 are at the same position in the stacking direction. The second planar portion 132 and the fourth planar portion 134 are at the same position in the stacking direction. The second planar portion 132 and the fourth planar portion 134 are positioned farther in the first stacking direction Z1 than the first planar portion 131 and the third planar portion 133. The second planar portion 132 and the fourth planar portion 134 are in contact with the sensor layer 70.

In the fourth modification described above, the sensor layer 70 comes into contact only with the second planar portion 132 and the fourth planar portion 134 when the force applied to the detection surface 1 is small. When the force applied to the detection surface 1 increases, the sensor layer 70 also comes into contact with the first planar portion 131 and the third planar portion 133.

As described above, the contact area between the sensor layer 70 and the detection electrode 120D of the detection device 100D according to the fourth modification does not increase unless the force applied to the detection surface 1 increases. Therefore, the amount of current flowing to the detection electrode 120D can be reduced, and the force-sensing range can be expanded. The reduction in sensitivity can also be prevented.

What is claimed is:

1. A detection device comprising:
an array substrate; and
a sensor layer facing the array substrate, wherein
the array substrate comprises:
a first surface facing the sensor layer; and
a plurality of detection electrodes provided to the first surface, and
the detection electrodes each comprise:
a first detection portion; and
a second detection portion disposed closer to the sensor layer than the first detection portion.

2. The detection device according to claim 1, wherein
a direction in which the array substrate and the sensor layer are disposed is a stacking direction,
the detection electrode comprises:
a plurality of planar portions extending in a planar direction parallel to the first surface; and
a vertical wall extending in the stacking direction,
the planar portions include a first planar portion and a second planar portion that are located at different positions in the stacking direction,
the vertical wall couples the first planar portion and the second planar portion,
the detection electrode has a stepped section along the stacking direction,
the first detection portion is the first planar portion, and
the second detection portion is the second planar portion.

3. The detection device according to claim 2, wherein the first planar portion, the second planar portion, and the vertical wall have an annular shape around a center of the detection electrode when viewed from the stacking direction.

4. The detection device according to claim 1, wherein
a direction in which the array substrate and the sensor layer are disposed is a stacking direction,
the detection electrode comprises:
a planar portion extending in a planar direction parallel to the first surface; and
a plurality of protrusions protruding from the planar portion in the stacking direction,
the protrusions each have a semicircular section along the stacking direction,
the first detection portion is the planar portion, and
the second detection portion is an apex of the protrusion.

5. The detection device according to claim 4, wherein the protrusions protrude toward the sensor layer.

6. The detection device according to claim 4, wherein the protrusions protrude in a direction opposite to a direction in which the sensor layer is disposed.

7. The detection device according to claim 1, wherein
a direction in which the array substrate and the sensor layer are disposed is a stacking direction,
the detection electrode comprises a plurality of planar portions extending in a planar direction parallel to the first surface,
the planar portions include:
a first planar portion;
a second planar portion located at a position different from that of the first planar portion in the stacking direction; and
a third planar portion located at the same position as that of the first planar portion in the stacking direction,
the second planar portion is provided between the first planar portion and the second planar portion,
the first detection portion is the first planar portion, and
the second detection portion is the second planar portion.

8. The detection device according to claim 7, wherein the first planar portion, the second planar portion, and the third planar portion have an annular shape around a center of the detection electrode when viewed from the stacking direction.
